(19) United States
(12) Patent Application Publication
(10) Pub. No.: US 2025/0237988 A1
(43) Pub. Date: Jul. 24, 2025

(54) IMAGE FORMING APPARATUS AND IMAGE FORMING SYSTEM

(71) Applicant: CANON KABUSHIKI KAISHA, Tokyo (JP)

(72) Inventor: HIROSHI KOYAMA, Tokyo (JP)

(21) Appl. No.: 19/004,711

(22) Filed: Dec. 30, 2024

(30) Foreign Application Priority Data
Jan. 19, 2024 (JP) 2024-006727

(51) Int. Cl. G03G 15/00

(52) U.S. Cl. CPC G03G 15/6552; G03G 15/6573; G03G 15/6579

(57) ABSTRACT

An image forming system includes an image forming apparatus and a discharging apparatus. The image forming apparatus includes a first discharging portion, and a first conveyance path. The discharging apparatus includes a second discharging portion, a second conveyance path, and a first switching portion. The first switching portion is switched between a first position and a second position, the first position being a position at which the first switching portion guides the sheet, conveyed from an image forming portion, toward the first discharging portion through the first conveyance path, the second position being a position at which the first switching portion guides the sheet, conveyed from the image forming portion, toward the second discharging portion through the second conveyance path. The image forming apparatus further includes a third conveyance path, a reversing roller pair, and a fourth conveyance path.

### BACKGROUND OF THE INVENTION

### Field of the Invention

The present invention relates to an image forming apparatus, such as a copying machine or a printer, in which an electrophotographic system, an electrostatic recording system, or an ink-jet system is used, and to an image forming system in which a discharging apparatus that discharges sheets is attached to the image forming apparatus.

### Description of the Related Art

Japanese Patent Application Publication No. 2021-86034 discloses an image forming system, such as a copying machine or a printer, that includes an image forming apparatus and a discharging apparatus. The image forming apparatus includes an image forming portion. The discharging apparatus is detachably attached to the image forming apparatus and discharges sheets conveyed from the image forming apparatus. In the image forming system, a sheet on which an image is formed in the image forming portion is discharged to a first discharging tray disposed in the image forming apparatus, or to a second discharging tray disposed in the discharging apparatus. In the image forming apparatus, a first conveyance path for conveying a sheet to the first discharging tray is disposed; in the discharging apparatus, a second conveyance path branched from the first conveyance path and used for conveying a sheet to the second discharging tray is disposed. In addition, in the image forming apparatus, a switching portion is disposed. The switching portion pivots, and thereby switches the conveyance paths of a sheet conveyed from the image forming portion, for conveying the sheet to the first conveyance path or the second conveyance path.

In addition, in the image forming system, there is a case in which the discharging apparatus is removed and the image forming apparatus is used standalone. In this case, a cover is attached to an attached portion to which the discharging apparatus was attached. That is, either of the discharging apparatus or the cover can be selected, and attached to and detached from the image forming apparatus.

However, in the above-described image forming system described in Japanese Patent Application Publication No. 2021-86034, since the switching portion is disposed in the apparatus body of the image forming apparatus, the number of components of the apparatus body of the image forming apparatus increases. Thus, in a case where a sheet jam occurs in the apparatus body, it may become difficult to handle the sheet.

An object of the present invention is to provide an image forming apparatus and an image forming system that allow a user to easily handle the sheet in a case where a sheet jam occurs.

### SUMMARY OF THE INVENTION

According to a first aspect of the present invention, an image forming system includes an image forming apparatus including an image forming portion configured to form an image on a sheet, and a discharging apparatus detachably attached to a top portion of the image forming apparatus. The image forming apparatus includes a first discharging portion configured to discharge the sheet, and a first conveyance path, the sheet being configured to be conveyed from the image forming portion to the first discharging portion through the first conveyance path in the image forming apparatus. The discharging apparatus includes a second discharging portion configured to discharge the sheet, a second conveyance path connected to the first conveyance path in a state where the discharging apparatus is attached to the image forming apparatus, the sheet being configured to be conveyed from the first conveyance path to the second discharging portion through the second conveyance path, and a first switching portion configured to be switched between a first position and a second position, the first position being a position at which the first switching portion guides the sheet, conveyed from the image forming portion, toward the first discharging portion through the first conveyance path, the second position being a position at which the first switching portion guides the sheet, conveyed from the image forming portion, toward the second discharging portion through the second conveyance path. The image forming apparatus further includes a third conveyance path branched from the first conveyance path at a position upstream of a first connection position in a sheet conveyance direction, the first connection position being a position at which the second conveyance path is connected to the first conveyance path, the sheet being conveyed in the third conveyance path, a reversing roller pair configured to reverse a conveyance direction of the sheet conveyed in a first direction through the third conveyance path to a second direction opposite to the first direction, and convey the sheet in the second direction, and a fourth conveyance path connected to the third conveyance path at a second connection position upstream of the reversing roller pair in the first direction, the sheet which has been conveyed through the third conveyance path in the second direction being configured to be reconveyed to the image forming portion through the fourth conveyance path.

According to a second aspect of the present invention, an image forming apparatus includes an image forming portion configured to form an image on a sheet, a first discharging portion configured to discharge the sheet, a first conveyance path, the sheet being configured to be conveyed from the image forming portion to the first discharging portion through the first conveyance path in the image forming apparatus, an attached portion to which a discharging apparatus is configured to be attached, wherein the discharging apparatus includes a second discharging portion configured to discharge the sheet, a second conveyance path connected to the first conveyance path in a state where the discharging apparatus is attached to the image forming apparatus, the sheet being configured to be conveyed from the first conveyance path to the second discharging portion through the second conveyance path, and a switching portion configured to be switched between a first position and a second position, the first position being a position at which the switching portion guides the sheet, conveyed from the image forming portion, toward the first discharging portion through the first conveyance path, the second position being a position at which the switching portion guides the sheet, conveyed from the image forming portion, toward the second discharging portion through the second conveyance path, and a cover configured to be detachably attached to the attached portion to which the discharging apparatus is not attached.

According to a third aspect of the present invention, an image forming system includes an image forming apparatus including an image forming portion configured to form an image on a sheet, and a discharging apparatus detachably attached to a top portion of the image forming apparatus. The image forming apparatus includes a first discharging portion configured to discharge the sheet, and a first conveyance path, the sheet being configured to be conveyed from the image forming portion to the first discharging portion through the first conveyance path in the image forming apparatus. The discharging apparatus includes a second discharging portion configured to discharge the sheet, a second conveyance path connected to the first conveyance path in a state where the discharging apparatus is attached to the image forming apparatus, the sheet being configured to be conveyed from the first conveyance path to the second discharging portion through the second conveyance path, and a guiding portion configured to guide the sheet, conveyed in the first conveyance path, toward the second conveyance path.

Further features of the present invention will become apparent from the following description of exemplary embodiments with reference to the attached drawings.

### BRIEF DESCRIPTION OF THE DRAWINGS

FIG. 1 is a perspective view illustrating an image forming system of a first embodiment.

FIG. 2 is a cross-sectional view illustrating the image forming system of the first embodiment.

FIG. 3 is a cross-sectional view illustrating the image forming system of the first embodiment in a state where a discharging apparatus is removed from the image forming system.

FIG. 4 is a perspective view illustrating an image forming system of a second embodiment.

FIG. 5 is a cross-sectional view illustrating the image forming system of the second embodiment.

FIG. 6 is a cross-sectional view illustrating the image forming system of the second embodiment in a state where a cover is removed from the image forming system.

FIG. 7 is a cross-sectional view illustrating an image forming system of a third embodiment.

FIG. 8 is a cross-sectional view illustrating an image forming system of a fourth embodiment.

### DESCRIPTION OF THE EMBODIMENTS

### First Embodiment

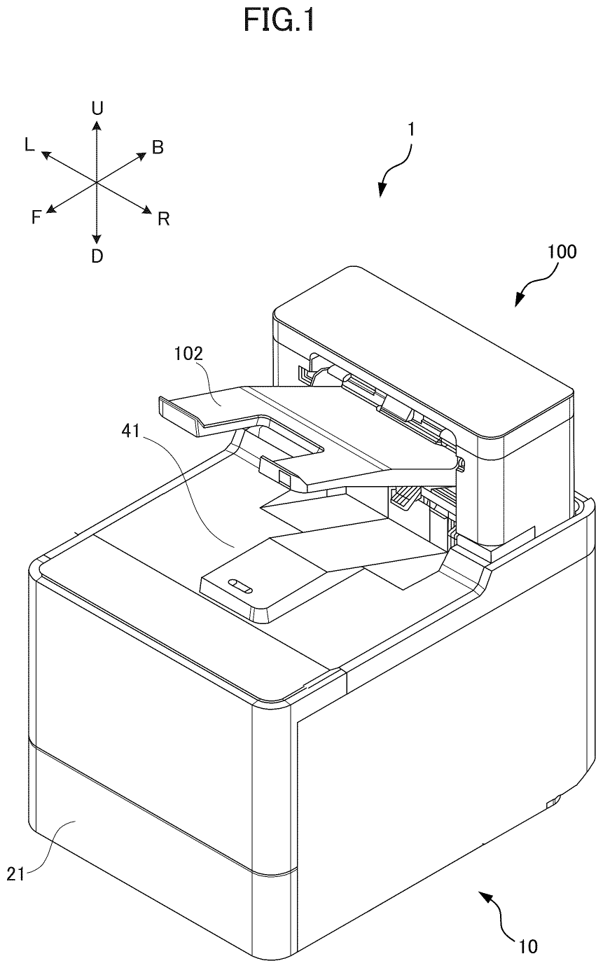

Hereinafter, a first embodiment of the present invention will be described in detail with reference to FIGS. 1 to 3. In the present embodiment, an image forming system 1 includes an image forming apparatus 10 and a discharging apparatus 100. The description will be made for a case where the image forming apparatus 10 is a tandem-type full-color printer, as one example. However, the present invention is not limited to the tandem-type image forming apparatus 10, and may be applied to other types of the image forming apparatus. In addition, the present invention is not limited to full-color printers, and may be applied to monochrome or monocolor printers. Furthermore, the present invention may be applied to an image forming apparatus with an ink-jet recording system.

### Image Forming Apparatus

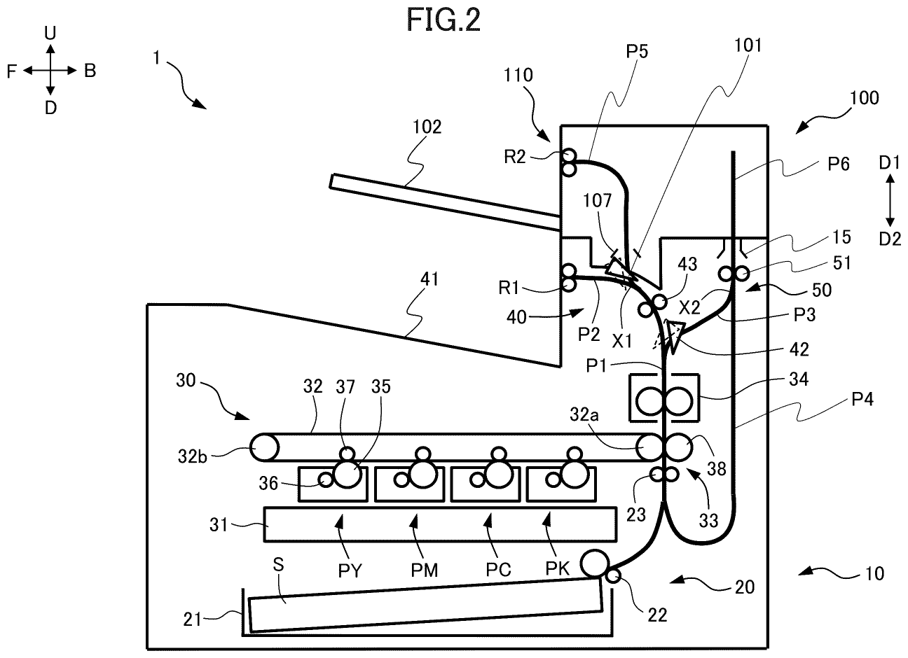

Next, an overall configuration of the whole of the image forming apparatus 10 will be described with reference to FIGS. 1 and 2. FIG. 1 is a perspective view of the image forming system 1 in a state where the discharging apparatus 100 is attached to the image forming apparatus 10 of the first embodiment. FIG. 2 is a cross-sectional view of the image forming system 1. Note that in the figures of the present embodiment, the front side of the image forming system 1 is expressed as a front direction F, the back side of the image forming system 1 is expressed as a back direction B, the right side of the image forming system 1 viewed from the front side is expressed as a right direction R, the left side of the image forming system 1 viewed from the front side is expressed as a left direction L, the upper side of the image forming system 1 viewed from the front side is expressed as an upward direction U, and the lower side of the image forming system 1 viewed from the front side is expressed as a downward direction D.

The image forming apparatus 10 includes a feeding unit 20, an image forming unit 30 that is one example of an image forming portion, a discharging unit 40, and a reconveyance unit 50. The feeding unit 20 includes a sheet cassette 21 that stores a sheet S, a feeding portion 22 that includes a roller pair for feeding the sheet S, and a registration roller pair 23. The registration roller pair 23 conveys the sheet S fed by the feeding portion 22, to the image forming unit 30 in synchronization with a timing of a toner image formed by the image forming unit 30.

The image forming unit 30 forms an image on the sheet S fed and conveyed by the feeding unit 20. The image forming unit 30 includes four process cartridges PY, PM, PC, and PK, an exposure unit 31, and an intermediate transfer belt 32. The four process cartridges PY, PM, PC, and PK are respectively used for forming four-color toner images of yellow (Y), magenta (M), cyan (C), and black (K). The four process cartridges PY, PM, PC, and PK are the same in configuration as each other, except that they produce different colors of image. For this reason, the configuration and the image forming process of only the process cartridge PY will be described, and the description for the process cartridges PM, PC, and PK will be omitted. The image forming unit 30 also includes a secondary transfer portion 33 and a fixing portion 34.

The process cartridge PY includes a photosensitive drum 35, a charging roller (not illustrated), and a developing roller 36. The photosensitive drum 35 is a drum-type electrophotographic photoreceptor. The photosensitive drum 35 is rotatably supported by the image forming apparatus 10, and is driven and rotated by a driving portion (not illustrated). The charging roller charges the photosensitive drum 35. The developing roller 36 causes the toner having a corresponding one of the different colors of yellow, magenta, cyan, and black to stick to the surface of the photosensitive drum 35 of a corresponding one of process cartridges PY, PM, PC, and PK. The developing roller 36 develops an electrostatic latent image by causing the toner to stick to an electrostatic latent image formed on the surface of the photosensitive drum 35, and thereby forms a toner image on the surface of the photosensitive drum 35. The exposure unit 31 emits a laser beam to the charged surface of the photosensitive drum 35 in accordance with image information, and thereby forms an electrostatic latent image.

The intermediate transfer belt 32 is wound around a driving roller 32a and a tension roller 32b, and stretched so as to be able to rotate. Inside the intermediate transfer belt 32, primary transfer rollers 37 are each disposed so as to abut against the intermediate transfer belt 32 at a position facing a corresponding photosensitive drum 35. At a position facing the driving roller 32a of the secondary transfer portion 33, a secondary transfer roller 38 is disposed for transferring an image formed on the intermediate transfer belt 32 onto the sheet S. The fixing portion 34 is disposed in the upward direction U of the secondary transfer roller 38, and includes a pressing roller and a heating roller. The sheet S on which the toner image is formed is heated and pressed at a roller nip portion formed by the pressing roller and the heating roller, so that the toners having respective colors are melted and mixed with each other and the toner image is fixed to the sheet S as a color image.

The discharging unit 40 is disposed in the upward direction U of the fixing portion 34, and includes a main-body conveyance path P1, a main-body discharge path P2, a first discharging roller pair R1 that is one example of a first discharging portion that discharges the sheet S, a main-body discharge tray 41, and a both-sides switching portion 42 that is a branching portion. In the present embodiment, a first discharging portion is disposed in the image forming apparatus 10 and used for discharging the sheet S, and includes the first discharging roller pair R1 alone. However, the present disclosure is not limited to this. For example, the image forming apparatus 10 may include a plurality of discharging roller pairs, and the plurality of discharging roller pairs may be switched for discharging the sheet S.

The main-body conveyance path P1 is disposed so as to extend upward from the fixing portion 34, and is connected to the main-body discharge path P2 at a first connection position X1. The main-body discharge path P2 conveys the sheet S from the first connection position X1 to the first discharging roller pair R1. The sheet S is discharged from the first discharging roller pair R1 to the main-body discharge tray 41, and is stacked on the main-body discharge tray 41. That is, the main-body conveyance path P1 and the main-body discharge path P2 are one example of a first conveyance path, and convey the sheet S from the image forming unit 30 to the first discharging roller pair R1 in the image forming apparatus 10.

The reconveyance unit 50 includes a first reverse path P3 that branches from the main-body conveyance path P1, a reversing roller pair 51 that is disposed in the first reverse path P3, and a reconveyance path P4 that branches at a position below the reversing roller pair 51 of the first reverse path P3. The first reverse path P3 is one example of a third conveyance path, and branches from the main-body conveyance path P1 at a position upstream of the first connection position X1 in the sheet conveyance direction. The reversing roller pair 51 reverses the conveyance direction of the sheet S conveyed in a first direction D1 through the first reverse path P3, and conveys the sheet S. Specifically, the reversing roller pair 51 reverses the conveyance direction such that the conveyance direction becomes a second direction D2 opposite to the first direction D1. The reconveyance path P4 is one example of a fourth conveyance path, and is connected to the first reverse path P3 at a second connection position X2 upstream of the reversing roller pair 51 in the first direction D1. In addition, the reconveyance path P4 reconveys the sheet S, which has been conveyed in the first reverse path P3 and whose conveyance direction has been reversed by the reversing roller pair 51 so as to become the second direction D2, to the image forming unit 30.

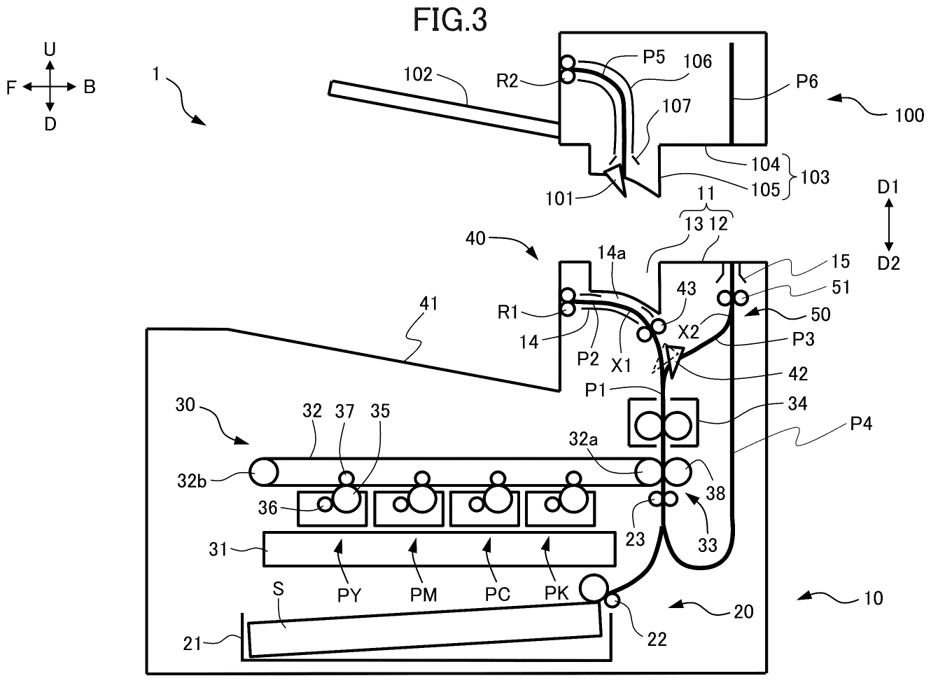

FIG. 3 is a cross-sectional view illustrating a state where the discharging apparatus 100 is removed from the image forming apparatus 10 of the first embodiment. As illustrated in FIG. 3, the image forming apparatus 10 includes an attached portion 11 that can be attached to a below-described attaching portion 103 of the discharging apparatus 100. The attached portion 11 includes an attached surface 12 and a recess portion 13. The attached surface 12 supports a below-described attaching surface 104 in a state where the attaching portion 103 is attached to the attached portion 11. The recess portion 13 is recessed, like a recess, downward from the attached surface 12. The recess portion 13 is a portion in which a below-described projection portion 105 configured to be engaged with the recess portion 13 is fit. The image forming apparatus 10 also includes a guide member 14 that forms the main-body discharge path P2. The guide member 14 is disposed in the downward direction D of the recess portion 13, and includes an opening 14a formed above the main-body discharge path P2. The opening 14a is exposed to the recess portion 13, and the main-body discharge path P2 is exposed to the opening 14a. The first connection position X1 is a position that faces the opening 14a. The upper end of the first reverse path P3 communicates with a communicating opening 15 that is exposed to the attached surface 12.

### Discharging Apparatus

Next, a configuration of the discharging apparatus 100 will be described with reference to FIGS. 1 to 3. The discharging apparatus 100 is detachably attached to a top portion of the image forming apparatus 10. As illustrated in FIG. 2, the discharging apparatus 100 includes a second discharging roller pair R2 that discharges the sheet S, an option discharge path P5 that conveys the sheet S from the first connection position X1 to the second discharging roller pair R2, a discharge switching portion 101, and an option discharge tray 102. The second discharging roller pair R2 is one example of a second discharging portion 110 that discharges the sheet S from the discharging apparatus 100. In the present embodiment, the second discharging portion 110 includes the second discharging roller pair R2 alone. However, the present disclosure is not limited to this. For example, the second discharging portion 110 may include a plurality of discharging roller pairs, and the plurality of discharging roller pairs may be switched for discharging the sheet S (see the fourth embodiment).

The option discharge path P5 is one example of a second conveyance path. The option discharge path P5 can be connected to the main-body conveyance path P1 in a state where the discharging apparatus 100 is attached to the image forming apparatus 10, and conveys the sheet S from the first connection position X1 of the main-body conveyance path P1 to the second discharging roller pair R2. The discharge switching portion 101 is one example of a first switching portion, and the discharge switching portion 101 is switched between a first position (indicated by a solid line in FIG. 2) and a second position (indicated by a broken line in FIG. 2) by pivoting the discharge switching portion 101. When positioned in the first position, the discharge switching portion 101 guides the sheet S conveyed from the image forming unit 30, toward the first discharging roller pair R1 through the main-body conveyance path P1 and the main-body discharge path P2. When positioned in the second position, the discharge switching portion 101 guides the sheet S conveyed from the image forming unit 30, toward the second discharging roller pair R2 through the option discharge path P5. The sheet S is discharged from the second discharging roller pair R2 to the option discharge tray 102, and is stacked on the option discharge tray 102.

The discharging apparatus 100 also includes a second reverse path P6 that is one example of a fifth conveyance path, and that is connected to the first reverse path P3 in a state where the discharging apparatus 100 is attached to the image forming apparatus 10. Thus, in a state where the discharging apparatus 100 is attached to the image forming apparatus 10, the first reverse path P3 and the second reverse path P6 form a retraction path. In the retraction path, the trailing edge of the sheet S that has been conveyed in the first direction D1 is retracted downstream of the second connection position X2 in the first direction D1.

As illustrated in FIG. 3, the discharging apparatus 100 includes the attaching portion 103. The attaching portion 103 includes the attaching surface 104 and the projection portion 105. The projection portion 105 projects, like a projection, downward from the attaching surface 104. The attaching portion 103 is attached to the attached portion 11, so that the discharging apparatus 100 is attached to the image forming apparatus 10.

The discharge switching portion 101 is disposed in a lower end portion of the projection portion 105. In a state where the discharging apparatus 100 is attached to the image forming apparatus 10, the discharge switching portion 101 positioned in the first position closes the opening 14a, and the guide member 14 of the image forming apparatus 10, together with the discharge switching portion 101, forms the main-body discharge path P2. The discharging apparatus 100 also includes a guide member 106 that is one example of a second guide member. The second guide member, together with the discharge switching portion 101 positioned in the second position, forms the option discharge path P5. The lower end of the option discharge path P5 communicates with a communicating opening 107 that is exposed to the projection portion 105.

### Conveyance Path for Discharging Sheet

Next, a configuration of a sheet conveyance path in a state where the discharging apparatus 100 is attached to the image forming apparatus 10 will be described with reference to FIG. 2. As illustrated in FIG. 2, the image forming system 1 includes the main-body conveyance path P1 through which the sheet S conveyed from the fixing portion 34 is conveyed. The image forming system 1 includes the main-body discharge path P2 which is branched from the main-body conveyance path P1 and through which the sheet S is conveyed to the main-body discharge tray 41, and the option discharge path P5 which is branched from the main-body conveyance path P1 and through which the sheet S is conveyed to the discharging apparatus 100.

The image forming system 1 also includes the reconveyance path P4 that is branched from the main-body conveyance path P1. In the reconveyance path P4, the sheet S is switch-backed and conveyed to the image forming unit 30 again. The image forming system 1 includes the communicating opening 15, the communicating opening 107, the both-sides switching portion 42, and the discharge switching portion 101. The communicating opening 15 is formed in a back portion of an upper surface of the image forming apparatus 10 so that the sheet S can pass through. Each of the both-sides switching portion 42 and the discharge switching portion 101 switches the conveyance paths of the sheet S.

The main-body conveyance path P1 is disposed so as to extend from the fixing portion 34 toward a point in front of and obliquely above the fixing portion 34. In the main-body conveyance path P1, a conveyance roller pair 43 is disposed for conveying the sheet S. The main-body discharge path P2 is disposed so as to extend from the first connection position X1, which is the upper end portion of the main-body conveyance path P1, toward a point in front of and obliquely above the first connection position X1. Thus, the sheet conveyance path, formed by the main-body conveyance path P1 and the main-body discharge path P2, extends away from the fixing portion 34 and is curved toward the main-body discharge tray 41. In the main-body discharge path P2, the first discharging roller pair R1 is disposed. The first discharging roller pair R1 is a roller pair disposed in the exit of the main-body discharge path P2, and discharges the sheet S to the main-body discharge tray 41.

The option discharge path P5 is disposed so as to extend upward from the first connection position X1 between the conveyance roller pair 43 in the main-body conveyance path P1 and the first discharging roller pair R1. The upper portion of the main-body conveyance path P1 communicates with the communicating opening 107. The communicating opening 107 causes the option discharge path P5 of the discharging apparatus 100 attached to the image forming apparatus 10 and the main-body conveyance path P1 to communicate with each other.

The reconveyance unit 50 includes the first reverse path P3 and the reconveyance path P4. The discharging apparatus 100 includes the second reverse path P6. The first reverse path P3 is disposed so as to extend upward and backward from the main-body conveyance path P1, and reaches the discharging apparatus 100 through the communicating opening 15. The second reverse path P6 is formed in the discharging apparatus 100, and extends upward, with one end of the second reverse path P6 being connected to the communicating opening 15. The reconveyance path P4 is branched from the first reverse path P3, and extends toward the image forming unit 30.

In the vicinity of a position below the communicating opening 15 of the first reverse path P3, the reversing roller pair 51 is disposed. The reversing roller pair 51 is a roller pair that conveys the sheet S sent from the main-body conveyance path P1 to the first reverse path P3. The reversing roller pair 51 is a switchback roller that can rotate in both of the forward and backward directions. By rotating in the forward direction, the reversing roller pair 51 temporarily conveys the sheet S conveyed in the first reverse path P3, upward from the communicating opening 15 toward the discharging apparatus 100 outside of the image forming apparatus 10, through the second reverse path P6 in the first direction D1. By rotating in the backward direction, the reversing roller pair 51 conveys the sheet S in the second direction D2 in which the sheet S is drawn into the image forming apparatus 10. The reconveyance path P4 extends downward from the first reverse path P3, curves frontward, extends upward from a position below the registration roller pair 23, and joins the feeding path at a position below the registration roller pair 23 that forms one pair.

The both-sides switching portion 42 is a member that switches conveyance directions of the sheet S at a branch portion of the main-body conveyance path P1 at which the first reverse path P3 is branched from the main-body conveyance path P1. The both-sides switching portion 42 is rotatably disposed in the image forming apparatus 10. The both-sides switching portion 42 is disposed so as to be able to be switched between a discharging position (indicated by a solid line in FIG. 2) and a both-sides conveyance position (indicated by a broken line in FIG. 2). When positioned in the discharging position, the both-sides switching portion 42 closes the first reverse path P3 for guiding the sheet S conveyed from the fixing portion 34, to the main-body discharge path P2. When positioned in the both-sides conveyance position, the both-sides switching portion 42 opens the reconveyance path P4 and closes the main-body discharge path P2 by swinging frontward from the discharging position, for guiding the sheet S conveyed from the fixing portion 34, to the reconveyance path P4.

The discharge switching portion 101 is a member that switches the conveyance directions of the sheet S at the first connection position X1 which is a branch portion at which the main-body discharge path P2 and the option discharge path P5 are branched. The discharge switching portion 101 is rotatably disposed in the discharging apparatus 100. In a case where the discharge switching portion 101 guides the sheet S conveyed from the conveyance roller pair 43, to the first discharging roller pair R1 along the main-body discharge path P2, the discharge switching portion 101 is positioned in a first position (indicated by a solid line in FIG. 2) at which the discharge switching portion 101 closes the option discharge path P5. In a case where the discharge switching portion 101 guides the sheet S conveyed from the conveyance roller pair 43, to the option discharge path P5, the discharge switching portion 101 opens the option discharge path P5 by swinging frontward from the first position, and is positioned in a second position (indicated by a broken line in FIG. 2) at which the discharge switching portion 101 closes the main-body discharge path P2.

As described above, in the image forming system 1 of the present embodiment, the discharge switching portion 101 that switches destinations to which the sheet S is discharged is disposed not in the image forming apparatus 10, but in the discharging apparatus 100. Thus, in a case where a sheet jam occurs in the vicinity of the discharge switching portion 101, especially in the main-body discharge path P2 or the main-body conveyance path P1, the sheet can be easily handled by removing the discharging apparatus 100.

In contrast, if the discharge switching portion 101 is disposed in the image forming apparatus 10, the configuration of the image forming apparatus 10 becomes complicated, which may cause the deterioration of stability. In this case, the sheet jam may easily occur. However, in the image forming system 1 of the present embodiment, the discharge switching portion 101 is disposed not in the image forming apparatus 10, but in the discharging apparatus 100. Thus, since the number of components of the image forming apparatus 10 decreases, the rate of occurrence of sheet jam can be reduced, and the stability can be increased. In addition, the cost of the image forming apparatus 10 can be reduced.

### Second Embodiment

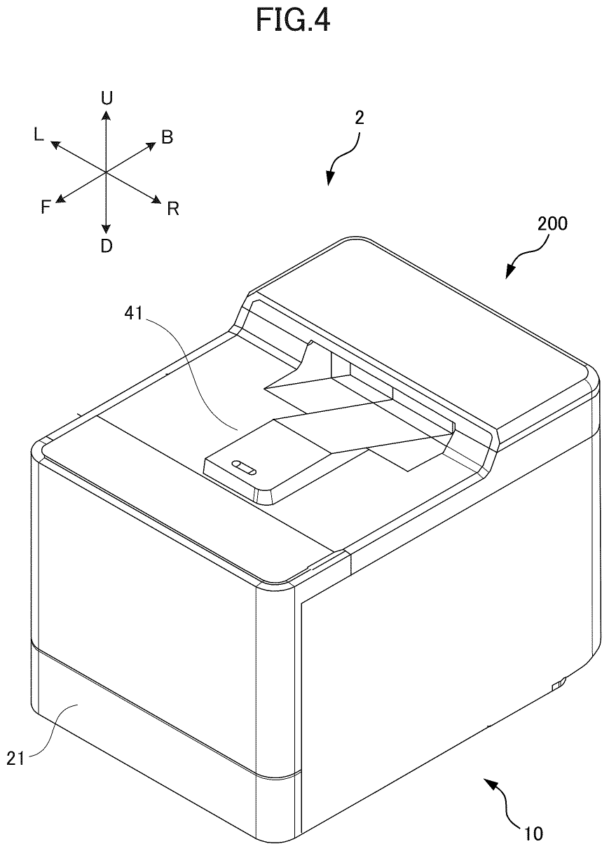

Next, a second embodiment of the present invention will be described in detail with reference to FIGS. 4 to 6. The present embodiment differs from the first embodiment in that instead of the discharging apparatus 100, a cover 200 is attached to the image forming apparatus 10. Since the other configuration of the image forming apparatus 10 is the same as that of the first embodiment, a component identical to a component of the first embodiment is given an identical symbol and the detailed description thereof will be omitted. In the present embodiment, an image forming system 2 includes an image forming apparatus 10 that is identical to the image forming apparatus 10 of the first embodiment, and the cover 200.

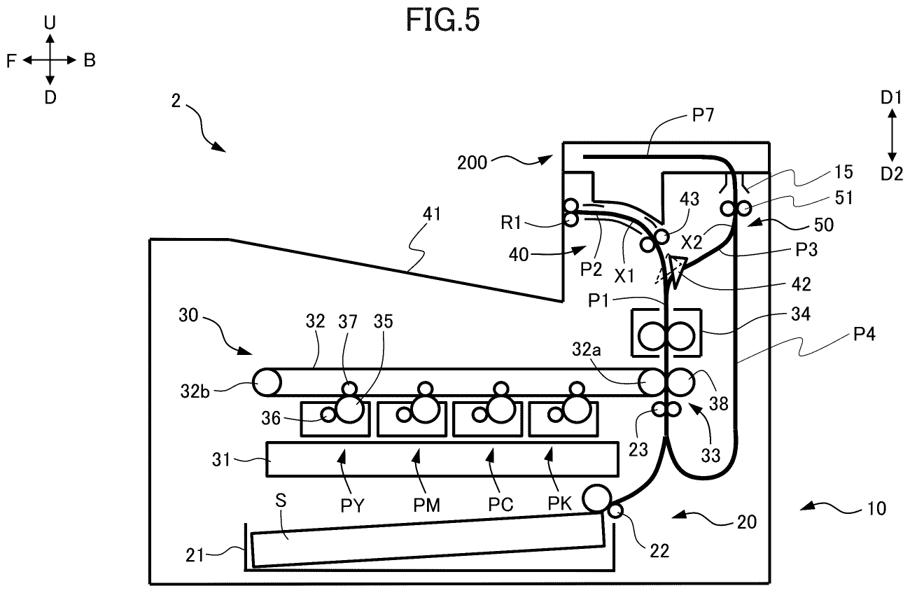

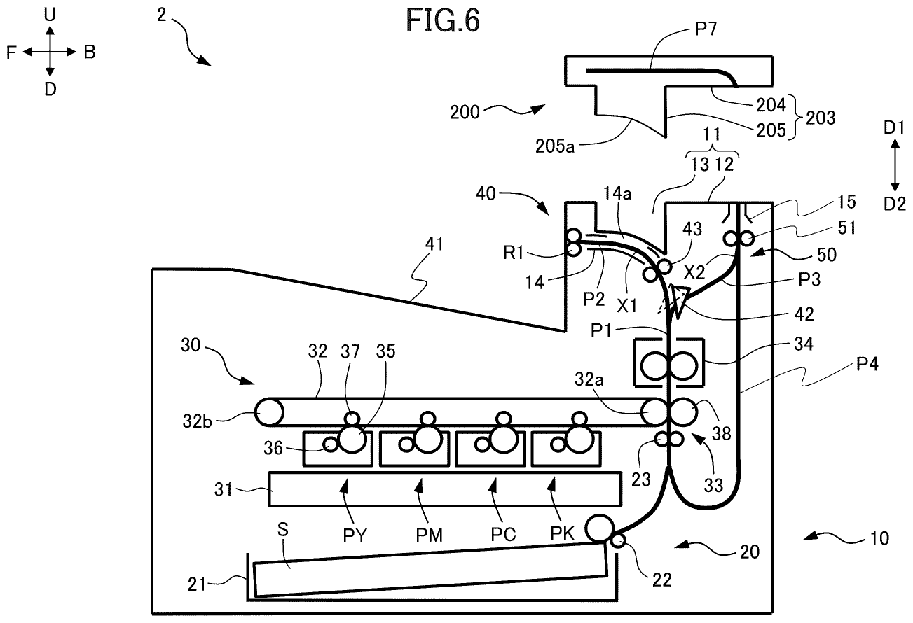

FIG. 4 is a perspective view illustrating a state where the cover 200 is attached to the image forming apparatus 10 of the first embodiment. FIG. 5 is a cross-sectional view illustrating a state where the cover 200 is attached to the image forming apparatus 10. FIG. 6 is a cross-sectional view illustrating a state where the cover 200 is removed from the image forming apparatus 10. The discharging apparatus 100 can be removed from the image forming apparatus 10 as illustrated in FIG. 3, and then, instead of the discharging apparatus 100, the cover 200 can be detachably attached to a top portion of the image forming apparatus 10 as illustrated in FIGS. 4 and 5.

The cover 200 includes a second reverse path P7 connected to the first reverse path P3 in a state where the cover 200 is attached to the image forming apparatus 10. Thus, in a state where the cover 200 is attached to the image forming apparatus 10, the first reverse path P3 and the second reverse path P7 form a retraction path. In the retraction path, the trailing edge of the sheet S that has been conveyed in the first direction DI is retracted downstream of the second connection position X2 in the first direction D1. The downstream end of the second reverse path P7 in the second direction D2 is connected to the communicating opening 15, and an upstream portion of the second reverse path P7 in the second direction D2 is formed so as to extend substantially horizontally in a front-back direction. Thus, the need for increasing the cover 200 in the upward direction can be eliminated, and the cover 200 can be made thinner.

As illustrated in FIG. 6, the cover 200 includes an attaching portion 203. The attaching portion 203 includes an attaching surface 204 and a projection portion 205. The projection portion 205 projects, like a projection, downward from the attaching surface 204. The attaching portion 203 is attached to the attached portion 11, so that the cover 200 is attached to the image forming apparatus 10. In the lower end portion of the projection portion 205, a guide portion 205a is formed. In a state where the cover 200 is attached to the image forming apparatus 10, the guide portion 205a closes the opening 14a, and the guide member 14 of the image forming apparatus 10, together with the guide portion 205a, forms the main-body discharge path P2.

### Conveyance Path for Discharging Sheet

Next, a configuration of a sheet conveyance path in a state where the cover 200 is attached to the image forming apparatus 10 will be described with reference to FIG. 5. As illustrated in FIG. 5, in a configuration in which the cover 200 is attached to the image forming apparatus 10, the communicating opening 107 and the discharge switching portion 101 of the first embodiment are not disposed. Thus, the sheet S is always conveyed to the main-body discharge path P2 and the main-body discharge tray 41, without being conveyed from the main-body conveyance path P1 to the discharging apparatus 100. For this reason, as illustrated in FIG. 6, the guide portion 205a is formed in the cover 200, for guiding the sheet S in the main-body conveyance path P1 and the main-body discharge path P2.

In the reconveyance, as in the first embodiment, by rotating in the forward direction, the reversing roller pair 51 temporarily conveys the sheet S conveyed in the first reverse path P3, from the communicating opening 15 toward the cover 200 outside of the image forming apparatus 10, through the second reverse path P7 in the first direction D1. In addition, by rotating in the backward direction, the reversing roller pair 51 conveys the sheet S toward the second direction D2 in which the sheet S is drawn into the image forming apparatus 10.

As described above, in the image forming system 2 of the present embodiment, the discharge switching portion 101 that switches destinations to which the sheet S is discharged is not disposed in the image forming apparatus 10. Thus, in a case where a sheet jam occurs in the main-body discharge path P2, the main-body conveyance path P1, or the communicating opening 15, the sheet can be easily handled by removing the cover 200. Since the number of components of the image forming apparatus 10 decreases, the rate of occurrence of sheet jam can be reduced, and the stability can be increased. In addition, the cost of the image forming apparatus 10 can be reduced. In addition, since the cover 200 includes only the guide portion 205a and the second reverse path P7, the configuration of the cover 200 can be simplified.

In addition, the configuration of the image forming apparatus 10 for attaching the discharging apparatus 100 to the image forming apparatus 10 can be made equal to the configuration of the image forming apparatus 10 for attaching the cover 200 to the image forming apparatus 10. As a result, the number of components of the image forming apparatus 10 decreases, and the configuration of the image forming apparatus 10 can be simplified.

### Third Embodiment

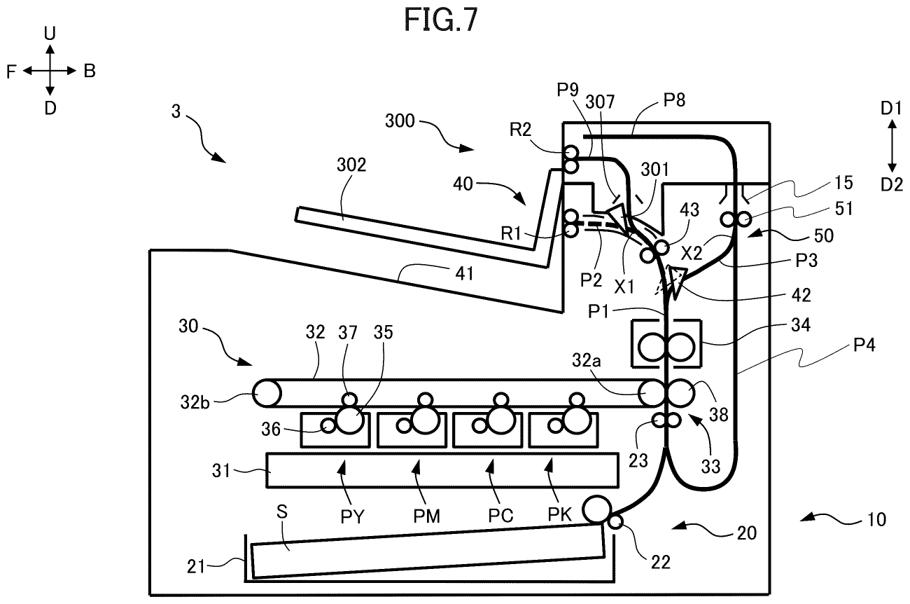

Next, a third embodiment of the present invention will be described in detail with reference to FIG. 7. The present embodiment differs from the first embodiment in that instead of the discharging apparatus 100, a discharging apparatus 300 is attached to the image forming apparatus 10. Since the other configuration of the image forming apparatus 10 is the same as that of the first embodiment, a component identical to a component of the first embodiment is given an identical symbol and the detailed description thereof will be omitted. In the present embodiment, an image forming system 3 includes an image forming apparatus 10 that is identical to the image forming apparatus 10 of the first embodiment, and the discharging apparatus 300.

As illustrated in FIG. 7, the discharging apparatus 300 includes a second reverse path P8 connected to the first reverse path P3 in a state where the discharging apparatus 300 is attached to the image forming apparatus 10. Thus, in a state where the discharging apparatus 300 is attached to the image forming apparatus 10, the first reverse path P3 and the second reverse path P8 form a retraction path. In the retraction path, the trailing edge of the sheet S that has been conveyed in the first direction D1 is retracted downstream of the second connection position X2 in the first direction D1. The downstream end of the second reverse path P8 in the second direction D2 is connected to the communicating opening 15, and an upstream portion of the second reverse path P8 in the second direction D2 is formed so as to extend substantially horizontally in the front-back direction. Thus, the need for increasing the discharging apparatus 300 in the upward direction can be eliminated, and the discharging apparatus 300 can be made thinner.

The discharging apparatus 300 includes a second discharging roller pair R2 that discharges the sheet S, an option discharge path P9 that conveys the sheet S from the first connection position X1 to the second discharging roller pair R2, a switching portion 301, and an option discharge tray 302. The option discharge path P9 is one example of a second conveyance path. The option discharge path P9 is connected to the main-body conveyance path P1 in a state where the discharging apparatus 300 is attached to the image forming apparatus 10, and conveys the sheet S from the first connection position X1 of the main-body conveyance path P1 to the second discharging roller pair R2. The switching portion 301 is one example of a guiding portion, and guides the sheet conveyed in the main-body conveyance path P1, to the option discharge path P9. That is, in the present embodiment, the switching portion 301 is a member that switches conveyance directions of the sheet S at the first connection position X1. The switching portion 301 is, however, positioned in the second position for always guiding the sheet S to the option discharge path P9. The sheet S is discharged from the second discharging roller pair R2 to the option discharge tray 302, and is stacked on the option discharge tray 302. The option discharge tray 302 is disposed in a sheet storage space so as to extend from the second discharging roller pair R2 toward the main-body discharge tray 41, and a large number of sheets can be stacked on the option discharge tray 302.

As described above, in the image forming system 3 of the present embodiment, the switching portion 301 that switches destinations to which the sheet S is discharged is not disposed in the image forming apparatus 10. Thus, in a case where a sheet jam occurs in the main-body discharge path P2, the main-body conveyance path P1, or the communicating opening 15, the sheet can be easily handled by removing the discharging apparatus 300. Since the number of components of the image forming apparatus 10 decreases, the rate of occurrence of sheet jam can be reduced, and the stability can be increased. In addition, the cost of the image forming apparatus 10 can be reduced.

In addition, in the image forming system 3 of the present embodiment, the option discharge tray 302 can be disposed at a position lower than the position of the option discharge tray 102 of the first embodiment, and the second reverse path P8, which is one portion of the retraction path formed in the discharging apparatus 300, extends frontward. Thus, the image forming apparatus 10 can be made smaller than that of the first embodiment.

Note that in the above-described present embodiment, the switching portion 301, which is movable, is positioned at the second position. However, the present disclosure is not limited to this. For example, instead of the switching portion 301, a guiding portion that is fixed and immovable at the second position may be attached to the discharging apparatus 300, and may guide the sheet conveyed in the main-body conveyance path P1, to the option discharge path P9.

### Fourth Embodiment

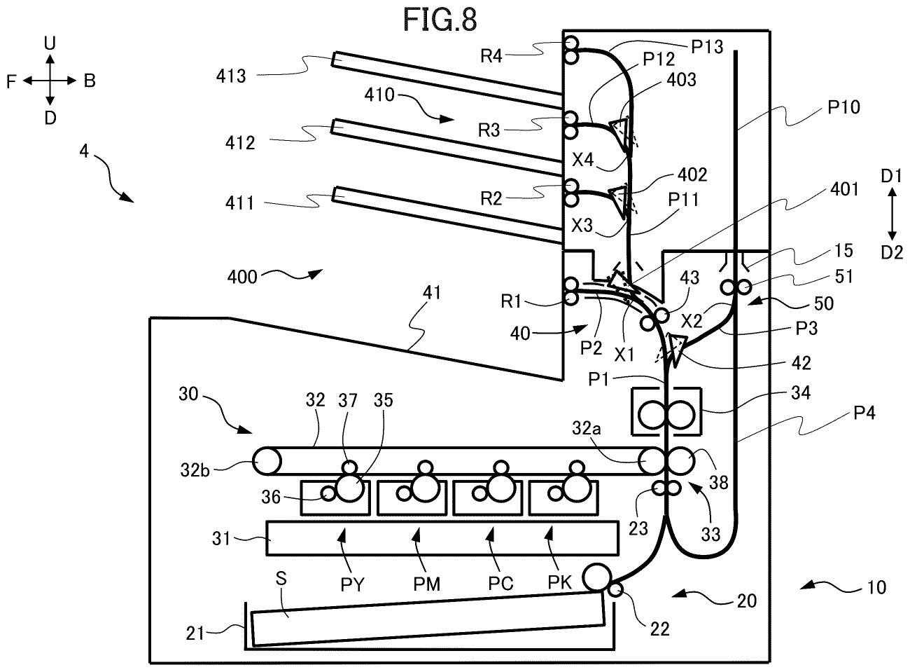

Next, a fourth embodiment of the present invention will be described in detail with reference to FIG. 8. The present embodiment differs from the first embodiment in that instead of the discharging apparatus 100, a multi-stage discharging apparatus 400 is attached to the image forming apparatus 10. Since the other configuration of the image forming apparatus 10 is the same as that of the first embodiment, a component identical to a component of the first embodiment is given an identical symbol and the detailed description thereof will be omitted. In the present embodiment, an image forming system 4 includes an image forming apparatus 10 that is identical to the image forming apparatus 10 of the first embodiment, and the discharging apparatus 400.

As illustrated in FIG. 8, the discharging apparatus 400 includes a first discharging tray 411, a second discharging tray 412, and a third discharging tray 413, which are disposed in the upward and downward direction. The discharging apparatus 400 can sort and discharge sheets S conveyed from the image forming apparatus 10, to the first discharging tray 411, the second discharging tray 412, and the third discharging tray 413. Note that the discharging apparatus 400 includes a second discharging portion 410 that discharges the sheet S. The second discharging portion 410 includes below-described second discharging roller pair R2, third discharging roller pair R3, and fourth discharging roller pair R4.

The second discharging roller pair R2 discharges the sheet to the first discharging tray 411. The discharging apparatus 400 includes a discharging path P11 for discharging the sheet conveyed from the image forming apparatus 10, to the first discharging tray 411. The discharging path P11 is one example of a second conveyance path that conveys the sheet S from the first connection position X1 to the second discharging roller pair R2.

The third discharging roller pair R3 discharges the sheet to the second discharging tray 412. The discharging apparatus 400 includes a discharging path P12 for discharging the sheet conveyed from the image forming apparatus 10, to the second discharging tray 412, and a second switching portion 402. The discharging path P12 can be connected to the discharging path P11 at a third connection position X3, and is one example of a sixth conveyance path that conveys the sheet S from the third connection position X3 to the third discharging roller pair R3. The second switching portion 402 is disposed on the way of the discharging path P11, and the second switching portion 402 is switched between a third position (indicated by a broken line in FIG. 8) and a fourth position (indicated by a solid line in FIG. 8) by pivoting the second switching portion 402. When positioned in the third position, the second switching portion 402 guides the sheet S conveyed from the image forming unit 30, toward the second discharging roller pair R2 through the discharging path P11. When positioned in the fourth position, the second switching portion 402 guides the sheet S conveyed from the image forming unit 30, toward the third discharging roller pair R3 through the discharging path P12.

The fourth discharging roller pair R4 discharges the sheet to the third discharging tray 413. The discharging apparatus 400 includes a discharging path P13 for discharging the sheet conveyed from the image forming apparatus 10, to the third discharging tray 413, and a third switching portion 403. The discharging path P13 can be connected to the discharging path P12 at a fourth connection position X4, and is one example of a seventh conveyance path that conveys the sheet S from the fourth connection position X4 to the fourth discharging roller pair R4. The third switching portion 403 is disposed on the way of the discharging path P12, and the third switching portion 403 is switched between a fifth position (indicated by a broken line in FIG. 8) and a sixth position (indicated by a solid line in FIG. 8) by pivoting the third switching portion 403. When positioned in the fifth position, the third switching portion 403 guides the sheet S conveyed from the image forming unit 30, toward the third discharging roller pair R3 through the discharging path P12. When positioned in the sixth position, the third switching portion 403 guides the sheet S conveyed from the image forming unit 30, toward the fourth discharging roller pair R4 through the discharging path P13.

The discharging apparatus 400 includes a second reverse path P10 connected to the first reverse path P3 in a state where the discharging apparatus 400 is attached to the image forming apparatus 10. Thus, in a state where the discharging apparatus 400 is attached to the image forming apparatus 10, the first reverse path P3 and the second reverse path P10 form a retraction path. In the retraction path, the trailing edge of the sheet S that has been conveyed in the first direction D1 is retracted downstream of the second connection position X2 in the first direction D1. The downstream end of the second reverse path P10 in the second direction D2 is connected to the communicating opening 15, and the second reverse path P10 is formed linearly so as to extend toward the upstream direction in the second direction D2. In the present embodiment, since the discharging apparatus 400 includes the three-stage first discharging tray 411, second discharging tray 412, and third discharging tray 413, the discharging apparatus 400 has a larger height. Thus, the length of the second reverse path P10 can be made larger, and thus the discharging apparatus 400 can handle a long-size sheet.

As described above, in the image forming system 4 of the present embodiment, the switching portion 401 that switches destinations to which the sheet S is discharged is not disposed in the image forming apparatus 10. Thus, in a case where a sheet jam occurs in the main-body discharge path P2, the main-body conveyance path P1, or the communicating opening 15, the sheet can be easily handled by removing the discharging apparatus 400. Since the number of components of the image forming apparatus 10 decreases, the rate of occurrence of sheet jam can be reduced, and the stability can be increased. In addition, the cost of the image forming apparatus 10 can be reduced.

In addition, since the length of the second reverse path P10, which is one portion of the retraction path formed in the discharging apparatus 400, is larger than the length of the second reverse path of the first embodiment, the image forming system 4 of the present embodiment can handle a long sheet.

The above-described embodiments allow a user to easily handle the sheet in a case where a sheet jam occurs.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-006727, filed Jan. 19, 2024, which is hereby incorporated by reference herein in its entirety.

What is claimed is:

1. An image forming system comprising:
an image forming apparatus including an image forming portion configured to form an image on a sheet; and
a discharging apparatus detachably attached to a top portion of the image forming apparatus,
wherein the image forming apparatus includes
a first discharging portion configured to discharge the sheet, and
a first conveyance path, the sheet being configured to be conveyed from the image forming portion to the first discharging portion through the first conveyance path in the image forming apparatus,
wherein the discharging apparatus includes
a second discharging portion configured to discharge the sheet,
a second conveyance path connected to the first conveyance path in a state where the discharging apparatus is attached to the image forming apparatus, the sheet being configured to be conveyed from the first conveyance path to the second discharging portion through the second conveyance path, and
a first switching portion configured to be switched between a first position and a second position, the first position being a position at which the first switching portion guides the sheet, conveyed from the image forming portion, toward the first discharging portion through the first conveyance path, the second position being a position at which the first switching portion guides the sheet, conveyed from the image forming portion, toward the second discharging portion through the second conveyance path, and
wherein the image forming apparatus further includes
a third conveyance path branched from the first conveyance path at a position upstream of a first connection position in a sheet conveyance direction, the first connection position being a position at which the second conveyance path is connected to the first conveyance path, the sheet being conveyed in the third conveyance path,
a reversing roller pair configured to reverse a conveyance direction of the sheet conveyed in a first direction through the third conveyance path to a second direction opposite to the first direction, and convey the sheet in the second direction, and
a fourth conveyance path connected to the third conveyance path at a second connection position upstream of the reversing roller pair in the first direction, the sheet which has been conveyed through the third conveyance path in the second direction being configured to be reconveyed to the image forming portion through the fourth conveyance path.

2. The image forming system according to claim 1, wherein the discharging apparatus includes an attaching portion,
wherein the image forming apparatus includes an attached portion to which the attaching portion is attached for attaching the discharging apparatus to the image forming apparatus,
wherein the attaching portion includes an attaching surface and a projection portion projecting downward from the attaching surface,
wherein the attached portion includes
an attached surface configured to support the attaching surface in a state where the attaching portion is attached to the attached portion, and
a recess portion which is recessed downward from the attached surface, and the projection portion being configured to be engaged with the recess portion, and
wherein the first switching portion is provided at a lower end portion of the projection portion.

3. The image forming system according to claim 1,
wherein the image forming apparatus includes a first guide member configured to form the first conveyance path with the first switching portion positioned at the first position, and
wherein the discharging apparatus includes a second guide member configured to form the second conveyance path with the first switching portion positioned at the second position.

4. The image forming system according to claim 1,
wherein the discharging apparatus includes a fifth conveyance path connected to the third conveyance path in the state where the discharging apparatus is attached to the image forming apparatus, and
wherein in the state where the discharging apparatus is attached to the image forming apparatus, the third conveyance path and the fifth conveyance path form a retraction path, a trailing edge of the sheet that has been conveyed through the retraction path in the first direction being configured to be retracted downstream of the second connection position in the first direction.

5. The image forming system according to claim 1, wherein the first discharging portion includes a first discharging roller pair.

6. The image forming system according to claim 1, wherein the second discharging portion includes a second discharging roller pair.

7. The image forming system according to claim 6,
wherein the second discharging portion further includes a third discharging roller pair, and
wherein the discharging apparatus includes
a sixth conveyance path connected to the second conveyance path at a third connection position, the sheet configured to be conveyed from the third connection position to the third discharging roller pair through the sixth conveyance path, and
a second switching portion configured to be switched between a third position and a fourth position, the third position being a position at which the second switching portion guides the sheet, conveyed from the image forming portion, toward the second discharging roller pair through the second conveyance path, the fourth position being a position at which the second switching portion guides the sheet, conveyed from the image forming portion, toward the third discharging roller pair through the sixth conveyance path.

8. The image forming system according to claim 7,
wherein the second discharging portion further includes a fourth discharging roller pair, and
wherein the discharging apparatus includes
a seventh conveyance path connected to the sixth conveyance path at a fourth connection position, the sheet configured to be conveyed from the fourth connection position to the fourth discharging roller pair through the seventh conveyance path, and
a third switching portion configured to be switched between a fifth position and a sixth position, the fifth position being a position at which the third switching portion guides the sheet, conveyed from the image forming portion, toward the third discharging roller pair through the sixth conveyance path, the sixth position being a position at which the third switching portion guides the sheet, conveyed from the image forming portion, toward the fourth discharging roller pair through the seventh conveyance path.

9. An image forming apparatus comprising:
an image forming portion configured to form an image on a sheet;
a first discharging portion configured to discharge the sheet;
a first conveyance path, the sheet being configured to be conveyed from the image forming portion to the first discharging portion through the first conveyance path in the image forming apparatus;
an attached portion to which a discharging apparatus is configured to be attached,
wherein the discharging apparatus includes
a second discharging portion configured to discharge the sheet,
a second conveyance path connected to the first conveyance path in a state where the discharging apparatus is attached to the image forming apparatus, the sheet being configured to be conveyed from the first conveyance path to the second discharging portion through the second conveyance path, and
a switching portion configured to be switched between a first position and a second position, the first position being a position at which the switching portion guides the sheet, conveyed from the image forming portion, toward the first discharging portion through the first conveyance path, the second position being a position at which the switching portion guides the sheet, conveyed from the image forming portion, toward the second discharging portion through the second conveyance path; and
a cover configured to be detachably attached to the attached portion to which the discharging apparatus is not attached.

10. An image forming system comprising:
an image forming apparatus including an image forming portion configured to form an image on a sheet; and
a discharging apparatus detachably attached to a top portion of the image forming apparatus,
wherein the image forming apparatus includes
a first discharging portion configured to discharge the sheet, and
a first conveyance path, the sheet being configured to be conveyed from the image forming portion to the first discharging portion through the first conveyance path in the image forming apparatus,
wherein the discharging apparatus includes
a second discharging portion configured to discharge the sheet,
a second conveyance path connected to the first conveyance path in a state where the discharging apparatus is attached to the image forming apparatus, the sheet being configured to be conveyed from the first conveyance path to the second discharging portion through the second conveyance path, and
a guiding portion configured to guide the sheet, conveyed in the first conveyance path, toward the second conveyance path.
